(19) United States
(12) Patent Application Publication
(10) Pub. No.: US 2012/0260652 A1
(43) Pub. Date: Oct. 18, 2012

(54) COMPRESSOR COMPRISING AN INSERT IN THE INLET REGION

(76) Inventors: Johannes Hiry, Tettnang (DE); Jörg Andre Reitz, Salem (DE)

(21) Appl. No.: 13/508,434

(22) PCT Filed: Nov. 4, 2010
(86) PCT No.: PCT/EP2010/006720

§ 371 Date: Jun. 26, 2012

(30) Foreign Application Priority Data
Nov. 6, 2009 (DE) 10 2009 052 162..

(51) Int. Cl. F01D 1/06; B23P 15/00; F02B 37/00

(52) U.S. Cl. 60/605.1; 415/203; 29/888.025

(57) ABSTRACT

The invention relates to a compressor assembly (1) and to a method for producing a compressor assembly (1), in particular for a turbocharger, wherein the compressor assembly (1) comprises a compressor housing (2) having a first inlet opening (6) for the inflow to a characteristic map-stabilizing gap (10), said opening having a first cross-section (7), and a second inlet opening (8) for the inflow to a channel (12) provided for forming a primary flow, said second opening having a second cross-section (9). The first (6) and the second (8) inlet openings are arranged radially adjacent to one another with respect to an inflow direction (5). The compressor assembly (1) comprises a tube section (3) arranged on the compressor housing (2) for the inflow to the first (6) and the second (8) inlet openings. The invention is characterized in that the tube section (3) is arranged at the compressor housing (2) by means of a first end (18), wherein the first end (18) has a cross-section (18a), which covers the first cross-section (7) of the first inlet opening (6) in a radial direction, at least in part.

### CROSS-REFERENCE TO RELATED APPLICATIONS

This application claims priority to German Patent Application 10 2009 052 162.3 filed on Nov. 6, 2009 and PCT/EP2010/006720 filed on Nov. 4, 2010, which are hereby incorporated by reference in their entireties.

### TECHNICAL FIELD

The present disclosure relates to a plate heat exchanger, in particular an oil cooler for an internal combustion engine, comprising several undulated heat exchanger plates which are stacked on top of each other.

### BACKGROUND

On the field of compressors of turbo chargers, in particular exhaust turbo chargers, various measures are known for stabilization of the engine characteristics. One possibility for stabilization is presented, e.g., in the document CH 675 279 A5, wherein the stabilization of engine characteristics is achieved by means of a stabilization ring and a recess or air gap in form of a ring-shaped slot. An additional design is known, e.g., from DE 40 27 174 C2, wherein an intake ring in addition affects the flow conditions positively.

With devices of this type for the stabilization of engine characteristics it is possible that unpleasant frequencies for the human ear, for example between 14 khz and 17 khz, will be created during the airflow through the slot for stabilization of engine characteristics around the compressor wheel, depending on the charger torque of the turbo charger or the compressor wheel. If the profile, e.g., the ring profile, of the slot is covered around the compressor wheel so that no sound is led into the inlet pipe, the high frequencies will be significantly reduced. For this purpose, for example, separate parts are used in the state of the art for acoustic shielding, e.g., metal sheet profiles or rotary parts, which, e.g., are kept over the snap rings, directly pressed in or fastened otherwise. These known solutions are elaborate in manufacturing, at times require several assembly steps and are costly.

On this basis, the present disclosure has the underlying purpose to propose a compressor configuration, which solves aforestated disadvantages, is implemented in a simple and cost-efficient way, and which suppresses the feedback of sound into the induction pipe, and in addition proposes a method for simple manufacturing of this kind of compressor configuration

### SUMMARY

The disclosure proposes a compressor configuration, in particular that of a turbo charger, comprising or including a compressor housing with a first inlet opening for inflow into a slot for stabilization of engine characteristics, comprising a first profile, as well as a second inlet opening for inflow into a channel intended as embodiment of a main flow characterized by a second profile, wherein the first and second inlet opening are arranged radially adjacent to each other relative to an inflow direction, while the compressor configuration comprises a pipe section arranged on the compressor housing for inflow into the first and second inlet opening, characterized in that the pipe section is arranged on the compressor housing by means of the first end, while the first end has a profile that at least partly covers the first profile of the first inlet opening in radial direction.

In an embodiment of the compressor configuration, the profile of the first end of the pipe section completely covers the first profile in radial direction.

According to another embodiment of the compressor configuration, a slot is formed in axial direction between the first end of the pipe section and the first inlet opening.

In addition, in an embodiment of the compressor configuration according to the invention it is intended that the first profile is a ring-shaped profile, which is arranged around the second profile in radial direction. The profile of the first end can therein essentially have the same shape as the first profile, i.e., the shape of the profile of the end corresponds with the shape of the first profile.

In an embodiment of the icompressor configuration, the profile of the inner channels of the pipe section corresponds with the second profile.

In another embodiment of the compressor configuration, the first end of the pipe section has an inner diameter that is tapered in the direction of the second end.

It is furthermore intended in a compressor configuration that the pipe section is embodied as plain conduit.

In addition, a compressor configuration is proposed wherein the pipe section by means of its first end is push-fit connected with the compressor housing. Furthermore, a compressor configuration is proposed wherein the pipe section by means of its second end is push-fit connected with an induction pipe.

In an embodiment of the compressor configuration, the pipe section is characterized by a contact pressure element for arrangement of the pipe section on the compressor housing and/or the induction pipe.

A combustion engine with a compressor configuration for compression of the charge air is furthermore also proposed.

Also proposed is a manufacturing method for a compressor configuration, in particular a compressor configuration, wherein a pipe section is push-fit connected with a compressor housing in the first step, and in the second step an induction pipe is push-fit connected with the pipe section.

Additional characteristics and advantages are shown in the following description of embodiment examples, by means of the figures and drawings and the Claims. The individual characteristics can each be embodied by themselves or in several optional combinations.

Preferred embodiments of the invention are explained in more detail in the following by means of the enclosed drawings

### BRIEF DESCRIPTION OF THE DRAWINGS

FIG. 1 shows an example of a compressor configuration;

FIG. 2 shows an example of a compressor configuration; and

FIG. 3 shows an example of a dismantled view of an inflow side of a compressor housing for a compressor configuration.

### DETAILED DESCRIPTION

In the following description and in the drawings, identical reference characters refer to elements with same or comparable function.

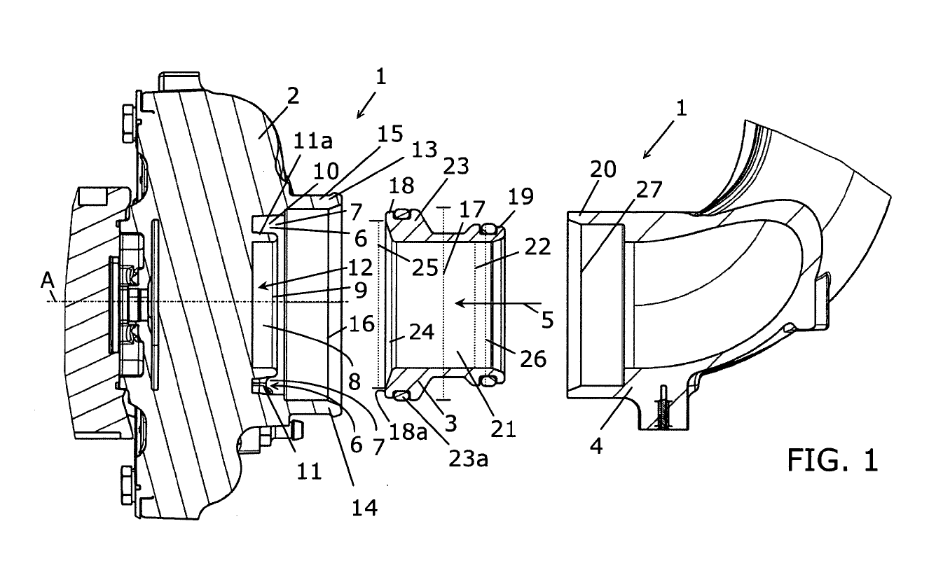

FIG. 1 shows an example of components of a compressor configuration 1 wherein the compressor configuration 1 is not yet assembled. The compressor configuration 1 comprises, e.g. a compressor housing 2, which can be connected with a pipe section 3 and in addition, for example, with an induction pipe 4.

The compressor configuration 1 is intended for use in a turbo charger, e.g., an exhaust gas turbo charger of a combustion engine or combustion motor, e.g., a V-motor. In this kind of known configuration, a compressor wheel (not shown) is powered by a turbine wheel that is installed torque resistant on the drive shaft of the compressor wheel in order to increase the supply of fresh air in consequence of the rotation of the compressor wheel for capacity increase of the motor.

The compressor configuration 1 is characterized by a housing or a compressor housing 2 wherein, e.g., the configuration of a compressor wheel is intended. For the inflow, e.g., of fresh air or conveying air (charge air) in an inflow direction 5 (arrow in FIG. 1), a first inlet opening 6 with a first profile 7 as well as a second inlet opening 8 with a second profile 9 is intended. The first 6 and second 8 inlet openings are, e.g., arranged radially adjacent to each other relative to the flow direction or a center axis A of the compressor housing 2, i.e., offset from each other on the center axis A in the direction of a perpendicular line. In particular, e.g., the second inlet opening 8 is located closer in radial direction to a center axis A than the first inlet opening 6.

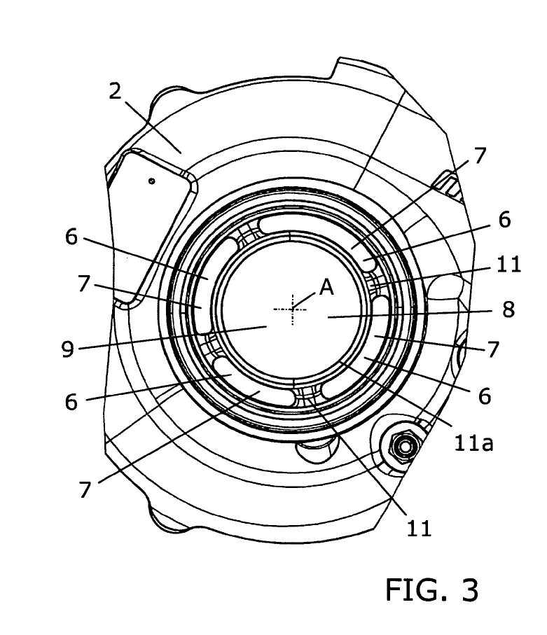

The first inlet opening 6 serves as embodiment of an airflow in a slot 10 for stabilization of engine characteristics or a channel for stabilization of engine characteristics, which is intended around a compressor wheel as measure for stabilization of engine characteristics. At this the inlet opening 6 can be segmented, e.g., interrupted by bars 11 (running in radial direction) (e.g., FIG. 3). The first inlet opening 6 is designed, e.g., ring-shaped, e.g., as circular ring, or it comprises a ring-shaped profile 7, which is, for example, arranged in radial direction around the second profile 9, e.g., arranged concentrically. Profile 7 is formed therein, e.g., by the surface of the ring shape.

The second inlet opening 8 serves as inflow into channel 12 wherein, e.g., the arrangement of the compressor wheel and, e.g., the embodiment of this main flow flowing into it is provided. The second inlet opening 8 is characterized, for example, by a circular shape profile and is, e.g., concentric to the first inlet opening 6 within the inner perimeter of the first inlet opening 6.

The first 6 and second 8 inlet openings are comprised, for example of a bar element or wall element 11a that are arranged concentrically to these and that run in axial direction, or the compressor housing 2, wherein the first 6 and the second 8 inlet opening, e.g., in terms of flow in the inlet area of the inflow, are connected.

For fastening or connection with a (connection) pipe element or pipe section 3, which is embodied, e.g., as plain conduit (i.e., for push-fit connection), the compressor housing 2, for example, furthermore has a connection element 13, e.g., a holding fixture 14, e.g., designed as a ring-shaped flange element 15 (ring flange), which, for example, is designed for holding one end of the push-fit pipe section 3. In addition, the connection element 13 or the holding fixture 14 can be designed, e.g., in form of a ring groove in the compressor housing 2. The connection element 13 shown in FIG. 1 in form of a holding fixture 14, includes, for example, the first 6 and second 8 inlet opening in radial direction and is arranged upstream from these, e.g., in axial direction in order to, e.g., lead or fix one end of a pipe section 3 held therein.

The connection with pipe section 3 is preferred as push-fit connection that can be implemented with little effort, e.g., as a permanent push-fit connection that cannot be loosened without destructive intervention. The connection could be designed force-fit, form-fit or even firmly bonded and also as a combination of this kind of connections. The connection element 13 or the holding fixture 14 comprise, for example, an inner perimeter 16, which is adjusted to an outer perimeter 17 of the pipe section 3 that is to be held therein, in particular characterized thereby that between connection element 13 and pipe section 3 a clamping force is created when a connection is made, i.e., an arrangement of the pipe section 3 on the compressor housing 2. At this the pipe section 3 is intended for arrangement on that compressor housing side, which comprises the first 6 and second 8 inlet openings (inflow side).

The compressor configuration 1 comprises a pipe section 3, which, for example, is an induction pipe 4, in particular however a pipe section 3 that is different from an induction pipe 4. The pipe section 3, which is, for example, designed as a sleeve comprises a first end 18, which when a connection is made with the compressor housing 2 or its connection element 13 is, e.g., arranged opposite in axial direction from the first 6 and second 8 inlet opening or their profiles, and also comprises a second end 19, which is designed as induction pipe end or preferably for connection with a compressor-side induction pipe end 20 of an induction pipe 4.

The pipe section 3 comprises, e.g., a channel, in particular a channel that is located on the inside, or an inner channel 21, which essentially comprises a first profile 22 wherein the profile 22 in an arrangement of the pipe section 3 on the compressor housing 2 is opposite from the profile 9 or the second inlet opening 8, e.g., in axial direction, and is adjusted, e.g., to the diameter or profile of the second inlet opening 8. The profiles of the inner channel 21, as well as the second inlet opening 8 correspond with each other in this respect. The profiles 22, 9 arranged opposite from each other in that way facilitate that a flow channel with identical cross-section can be formed from the inner channel 21 of pipe section 3, the second inlet opening 8 as well as the channel 12.

The first end 18 of pipe section 3 is moreover designed specifically for achieving a covering, at least a partial covering of the first inlet opening 6 or the first profile 7 in radial direction, especially for an arrangement on the compressor housing 2. The first, e.g., ring-shaped profile 7 is covered in radial direction, in particular around the flow cross-section, e.g., is completely covered in radial direction, by pipe section 3, which is, e.g., designed as plain conduit. An acoustic shielding is thereby achieved, which at least significantly reduces the feedback of disturbing frequencies, e.g., in the range between 14 kHz and 17 kHz, into the induction pipe 4.

For achieving the covering, which, e.g., is equivalent of an overlap of, in particular corresponding profiles, the first end 18 of the pipe section 3 comprises, e.g., a material profile or profile 18a that is suitable for the intended covering in the arrangement on the compressor housing 2. Profile 18a is, e.g., adjusted to the shape of the first profile 7 that is to be covered and is, e.g., ring-shaped. In order to design such a profile 18a, the first end 18 of the pipe section 3, e.g., in the area pointing toward the inflow side 23, is, e.g., shaped accordingly, e.g., reinforced or, e.g., broadened opposite the second end 19, e.g., by enlargement or expansion of the material profile of the pipe wall of pipe section 3. This profile 18a of the first end 18 in an arrangement on the compressor housing 2 for forming a compressor configuration 1 is located opposite from the first inlet opening 6, and thereby provides covering in radial direction.

In order to improve flow conditions in case of an inflow, e.g., profile 22 of the inner channel 21 in the section 23 is widened in the direction toward outlet opening 24 leading up to a second profile 25.

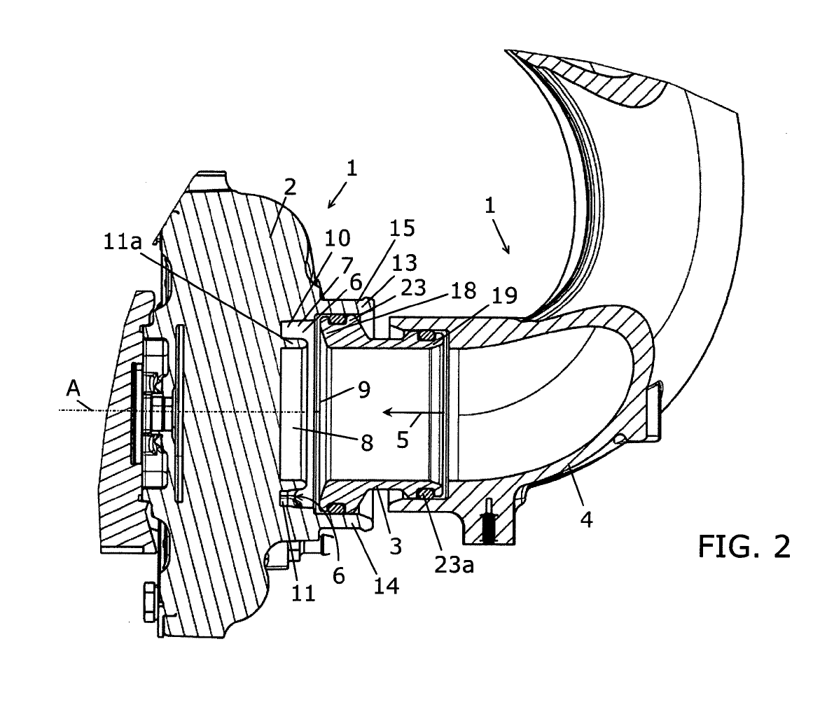

In order to ensure the airflow for proposes of stabilizing engine characteristics, and especially so not to create a closure of inlet opening 6, a slot in axial direction (inflow direction or direction of the center axis A) between the first inlet opening 6 and the first end 18 of pipe section 3 in an arrangement of pipe section 3 on compressor housing 2 is provided. The slot has, e.g., a width of 3 mm to 5 mm, e.g., between the ring-shaped bar 11a and the first end 18 of pipe section 3. With the flared inside diameter, e.g., in section 23 of pipe section 3, for example, an air channel with a beveled deflection (FIG. 2) between the first end 18 and the first inlet opening 6 is thus created. At the same time, for suppression of the sound feedback the first end 18, which is suited for this purpose together with profile 18a, is located opposite from the first profile 7.

The first end 18 of pipe section 3 is embodied or provided, for example by means of section 23, and furthermore for connection with the connection element 13, e.g., on the holding fixture 14 in form of, e.g., the ring flange 15. For this purpose the first end 18 has, e.g., an outer diameter 17, which is suitable for creating the intended connection. The connection can use the above described kinds of connections. For connection, the first end 18 can, e.g., in the reinforced section 23, have a flexible element, e.g., a contact pressure element 23a, which provides a permanent configuration or connection, e.g., by frictional connection or closed linkage. The contact pressure element 23a can, e.g., comprise sealing properties or, for example, support a push-fit connection between compressor housing and pipe section, e.g., by adhesion.

A second end 19 of, e.g., pipe section 3, designed as plain conduit is, for example, embodied as mentioned above for connection of a compressor-side induction pipe end 20, e.g., as an induction pipe 4. For this purpose, e.g., the outer diameter 26 of the second end 19 can be adjusted to the inner diameter 27 of the induction pipe end 20. It is also feasible to adjust an inner diameter of pipe section 3 to an outer diameter of the induction pipe end 20. The diameters 26, 27 are, for example, adjusted to each other or matched so that between the respective connecting ends of pipe section 3 and induction pipe 4 a clamping force in consequence of a connection, e.g., push-fit connection is created that results in a permanent connection, in particular such that cannot be loosened without destructive intervention. At this the second end 19 is, e.g., like the first end 18 of pipe section 3, also provided with a contact pressure element 23a on an outer perimeter, e.g., a sealing element.

For manufacturing the compressor configuration 1, a pipe section 3 is, for example, connected with a connection element 13 or a holding fixture 14 of the compressor housing 2, in particular by insertion, e.g., by push-fit connection of the first end 18 of pipe section 3 with the ring flange 15 of the compressor housing 2 in consequence of merging in axial direction. In another step, for example, the second end 19 of pipe section 3 is connected with a compressor-side end 20 of an induction pipe 4, in particular push-fitted, e.g., also by merging in axial direction.

For a combustion engine, e.g., a V-motor with a first and second cylinder bank (diesel motor, gasoline engine, etc.), which has a compressor configuration 1, the compressor configuration 1 is designed, e.g., for supply and compression of fresh air. Embodied therein is a compressor wheel arranged on the compressor housing 2, e.g., for purposes of charging the motor of a turbine wheel of a turbo charger that is connected to it. Thus, fresh air (charge air) can be supplied to a combustion chamber of a cylinder or a cylinder bank of the combustion engine in known way through a compressor outlet in consequence of a rotation of the compressor wheel that is initiated by the turbine wheel.

1. A compressor configuration of a turbo charger, comprising:
a compressor housing with a first inlet opening for inflow into a slot for stabilizing engine characteristics, which is characterized by a first profile as well as a second inlet opening for inflow into a channel for main flow, which has a second profile,
wherein the first and second inlet openings are arranged radially adjacent to each other relative to an inflow direction,
wherein the compressor configuration comprises a pipe section on the compressor housing for inflow into the first and second inlet opening, characterized in that the pipe section is arranged by the first end on the compressor housing, wherein the first end has a profile, which at least partially covers the first profile of the first inlet opening in a radial direction.

2. The compressor configuration according to claim 1 characterized in that the profile of the first end of the pipe section completely covers the first profile in the radial direction.

3. The compressor configuration according to claim 1 characterized in that between the first end of the pipe section and the first inlet opening, a slot is formed in an axial direction.

4. The compressor configuration according to claim 1 characterized in that the first profile is a ring-shaped profile, which is arranged around the second profile in the radial direction.

5. The compressor configuration according to claim 1 characterized in that the shape of the profile of the first end corresponds with the shape of the first profile.

6. The compressor configuration (1) according to claim 1 characterized in that a profile of an inner channel of the pipe section corresponds with the second profile.

7. The compressor configuration according to claim 1 characterized in that the first end of the pipe section has a profile, which is tapered in the direction of the second end.

8. The compressor configuration according to claim 1 characterized in that the pipe section is a push-fit pipe.

9. The compressor configuration according to claim 1 characterized in that the pipe section, by its first end, makes a push-fit connection with the compressor housing.

10. The compressor configuration according to claim 1 characterized in that the pipe section, by its second end, makes a push-fit connection with the induction pipe.

11. The compressor configuration according to claim 1 characterized in that the pipe section has a contact pressure element for the arrangement of the pipe section on the compressor housing or on the induction pipe.

12. A combustion engine comprising compressor configuration according to claim 1.

13. A process for manufacturing a compressor configuration according to claim 1, comprising:
push-fit connecting a pipe section with a compressor housing, and
push-fit connecting an induction pipe with the pipe section.
